(19) United States
(12) Patent Application Publication
(10) Pub. No.: US 2015/0301707 A1
(43) Pub. Date: Oct. 22, 2015

(54) System And Method Of Graphical User Interface With Map Overlay For Area Marking On Electronic Devices

(71) Applicant: KNORUM, INC., Budapest (HU)

(72) Inventors: Sandor Gabor TASNADI, Budapest (HU); Gabor SVED, Budapest (HU)

(73) Assignee: KNORUM, INC., Budapest (HU)

(21) Appl. No.: 14/256,953

(22) Filed: Apr. 19, 2014

(51) Int. Cl. G06F 3/0484

(52) U.S. Cl. CPC G06F 3/0484

(57) ABSTRACT

A system and method of graphical user interface with map overlay for area marking on electronic devices is provided. In the method an overlay is displayed above a mapping application. The overlay contains a transparent shape that marks an area on the map. The user can move the map and the marked area of the map is updated. The information about the marked area on the map is updated and is displayed on the overlay. The user can use other objects on the overlay to invoke predefined functions that are related to the map area marked by the overlay.

### FIELD OF THE INVENTION

The present invention relates generally to electronic devices with displays, and more particularly, to electronic devices with displays that provide mapping applications.

### BACKGROUND OF THE INVENTION

While the processing capacity of portable electronic devices is increasing and the software offering written for such devices is rapidly expanding, these devices are becoming increasingly compact. The reduced size of devices has led to the revolution of the touch screen which enables operation without the need for buttons and to the invention of gestures with which commands on touch screens can be executed efficiently.

Today most portable devices are equipped with mapping applications which are increasingly used for navigation, orientation or displaying information about geographical locations. Almost all mapping applications allow the users of portable devices to mark points of interest (POI) on the maps. POIs by definition relate to a single geographical location and not to a geographical area. Thus existing methods allow users to mark points but not areas on maps.

Given their small size, touch screen devices are increasingly used outdoors or on the go. When in motion, the users of the devices often prefer to operate them with one hand rather than with both. This is done by placing the portable device into the palm of the operating hand and by performing gestures with one finger, in most cases with the thumb.

The present invention discloses a system and method of graphical user interface with map overlay for area marking which enables the users of portable touch screen devices to mark areas in mapping applications with one user input such as a click or a finger gesture.

### SUMMARY OF THE INVENTION

The present invention seeks to overcome various limitations of the prior art. Generally speaking the invention provides a system and method for the users of devices to mark areas in mapping applications and to perform functions that are related to the marked areas with one user input such as a click or a finger gesture.

In one embodiment, the device is portable. In another embodiment, the device has a touch-sensitive display (also known as a “touch screen”) with a graphical user interface (GUI), one or more processors, memory and one or more modules, programs or sets of instructions stored in the memory for performing multiple functions. According to one embodiment, the user interacts with the GUI primarily through finger contacts and gestures on the touch-sensitive display.

In one embodiment, the device displays a mapping application above which a layer is projected. The layer may contain an area which may mark an area on the map underneath. Gestures made by the user may continue to move the map and thus affect the marked area on the map but may have no impact on the layer itself.

In another embodiment, the device displays a mapping application above which a layer is projected. The layer may contain transparent or non-transparent objects to present information about the area that is marked on the map. Such information may, for example, include details on all points of interest that are located in the selected area. Gestures made by the user may continue to move the map and thus change the marked area on the map. Such change in the marked area on the map may lead to an update of the information presented by the object of the overlay.

According to some embodiments, the device displays a mapping application above which a layer is projected. The layer may contain transparent or non-transparent objects that are linked to predefined functions to be performed by the device. Gestures made by the user on such an object may not move the map but may invoke functions defined in the program stored in the memory of the device. Such a function may, for example, send an email to the user containing a list of all points of interest that are located in the marked area.

In another embodiment, the layer area marking the area on the map underneath may have the form of a transparent shape with border. The shape may display to the user of the device a marked area on the map. Marked areas may be used by the program code stored in the device to update information displayed to the user.

In one embodiment the layer may include an object with a scroll function. Swiping the finger across the object may trigger predefined functions such as changing the zoom level of the underlying map.

### References to Existing Patents

There are several patents that describe systems and methods which share one or more attributes with the presented invention. However, none of them has the same objective of marking an area on a map with a map overlay.

U.S. Pat. No. 8,504,945 to Gabriel Jakobson, Steven Rueben describes a system for associating content with map zoom function. The invention displays content associated with a point-of-interest (“POI”) in a digital mapping system. In response to a “zoom in” command the POI informational content is retrieved from a data store and is displayed overlaying a portion of the map. The invention is using an overlay to present information on maps but is limited to the zoom function and to POIs. Thus it is not capable of marking areas and the overlay is not designed to contain objects that may be linked to predefined functions related to the marked areas.

U.S. Pat. No. 8,688,367 to Hans Peter Mauderer describes a navigation system and the storage and visualization of points of interest within. Users of the navigation system can add new points-of-interest (“POI”) to their navigation system in route. These POIs are individually personalized and are displayed on the map. However, this system doesn't use a map overlay, nor is it capable of marking areas on maps.

U.S. Pat. No. 8,694,245 to Michael Zubas, Mark Causey, Adrianne Luu describes methods, devices and computer program products for exchanging interactive map information between communication devices. The invention extends the transmission of static map information with the transmission of highlighted points-of-interest (POI) data between devices. Such a system is, however, not using a map overlay, nor is it capable of marking areas on maps.

U.S. Pat. No. 8,612,873 to Bing-Sheng Lin, Rubens Chu describes a method and apparatus for operating displayed areas of electronic maps. Points-of-Interest (POI) are displayed on electronic maps. In case a POI is outside the visible map area, the POI is displayed at the edge of the map area. When the POI on the edge of the map area is selected, the displayed map area changes so that the selected POI is in the centre of the new map area. As a result users can quickly navigate through maps from POI to POI, however, such a system doesn't use a map overlay, nor is it capable of marking areas on maps.

U.S. Pat. No. 8,302,033 to Michael Matas, Chris Blumenberg, Andre M. J. Boule, Stephen O. Lemay, Richard Williamson describes a touch screen device, method, and graphical user interface for providing maps, directions and location-based information. The method of navigating through maps with finger gestures on touch screens are described in detail. The invention does not cover the marking of areas and does not use a map overlay to display objects that may be linked to predefined functions related to the marked areas.

U.S. Pat. No. 8,688,670 to Sean Michael Imler, Kevin Cheng describes a system and method for dynamically retrieving data specific to a region of a layer. A region of a layer is selected, from which data points are used to retrieve data form a data source. As a result the user of a map application can search the geographic region based on a layer. A layer in this sense is a geographical area defined by the user and transmitted to the data source. As such, the layer is rather a tile of a map and not to be understood as a map overlay. Thus the invention is not using a map overlay to display objects that may be linked to predefined functions related to the marked area.

### BRIEF DESCRIPTION OF THE DRAWINGS

The foregoing and other aspects of the invention are discussed in greater detail below with reference to the accompanying drawings, provided for the purpose of description and not of limitation, wherein:

FIG. 1 is a schematic diagram of the display of an electronic portable device displaying a mapping application according to one embodiment;

FIG. 2 is a schematic diagram of an overlay which can be used in conjunction with the mapping application according to another embodiment;

FIG. 3 is a 3D-diagram of an overlay separated from the map display underneath to illustrate how the overlay is positioned in accordance with some embodiments;

FIG. 4 is a schematic diagram of the display of an electronic portable device displaying a mapping application with an overlay as seen from the perspective of the user in accordance with some embodiments;

FIG. 5 is a flow diagram illustrating the process of the map overlay with area marking with some embodiments.

While the invention is susceptible to various modifications and alternative forms, specific embodiments are shown by way of example in the drawings and are herein described in detail. It should be understood, however, that drawings and detailed description thereto are not intended to limit the invention to the to the particular form disclosed, but on the contrary, the invention is to cover all modifications, equivalents and alternatives falling within the spirit and scope of the present invention as defined by the appended claims.

### DETAILED DESCRIPTION OF PREFERRED EMBODIMENTS

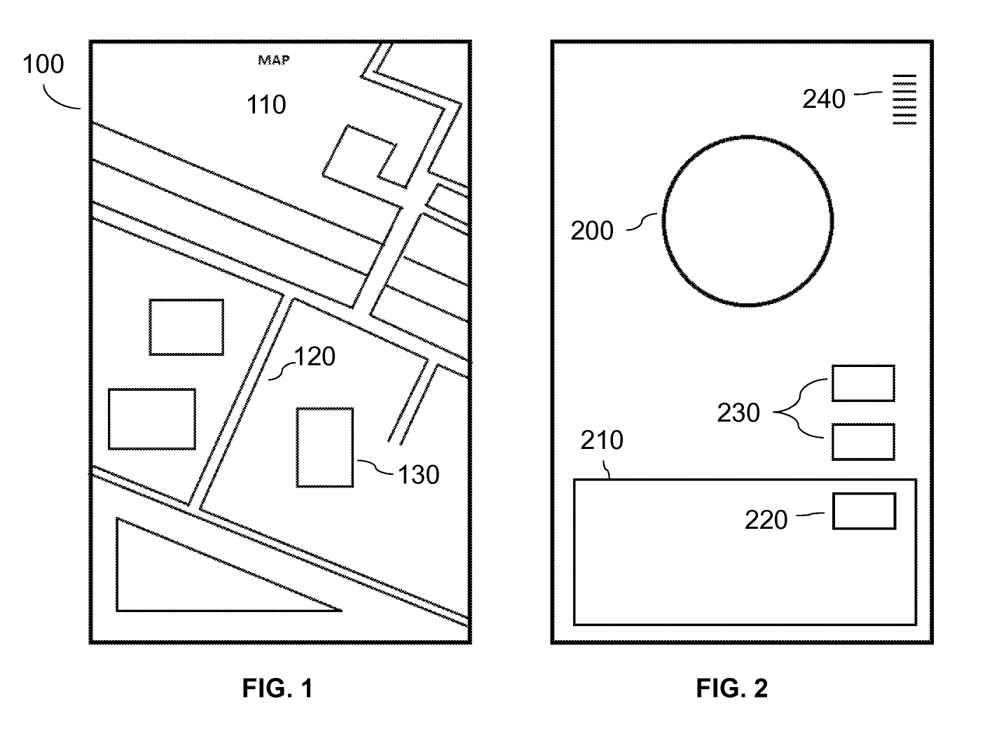

FIG. 1 shows an example of the display of an electronic portable device in an upright position. The display 100 shows a mapping application which presents a geographical map 110. Lines 120 and objects 130 on the map may mark streets, buildings and other objects.

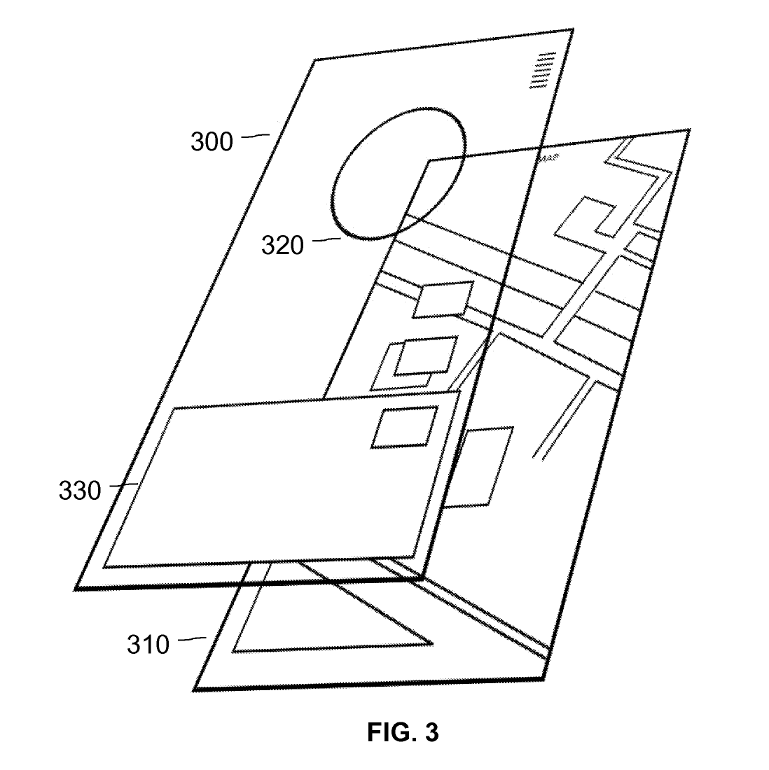

FIG. 2 illustrates an example of an overlay. The overlay may be transparent and may include several objects. A circle 200 may mark an area on the overlay and on the map at the same time, above which the overlay may be placed. An information box 210 may display information about the area that may be marked. A button 220 may be placed on the information box. Pushing the button may pull up further details about the marked area that may not have been displayed previously in the information box. Other buttons 230 may be placed on the layer independently from the information box to allow the user to invoke additional functions that may be related to the marked area. The display of the device might be touch-sensitive. An object may be displayed on the top of the display as a set of small horizontal lines 240 and may act as a slide control. The slide control may help the user to interact with the map more easily. A swipe with one finger from the bottom line to the top line may zoom the map in, while a swipe from the top line to the bottom line may zoom the map out.

FIG. 3 illustrates an example of the overlay 300 with a geographical map 310 underneath in 3D. The overlay may be placed and displayed above the map. Transparent parts of the overlay 320 let the map stay visible to the user while non-transparent objects 330 on the overlay may hide parts of the map.

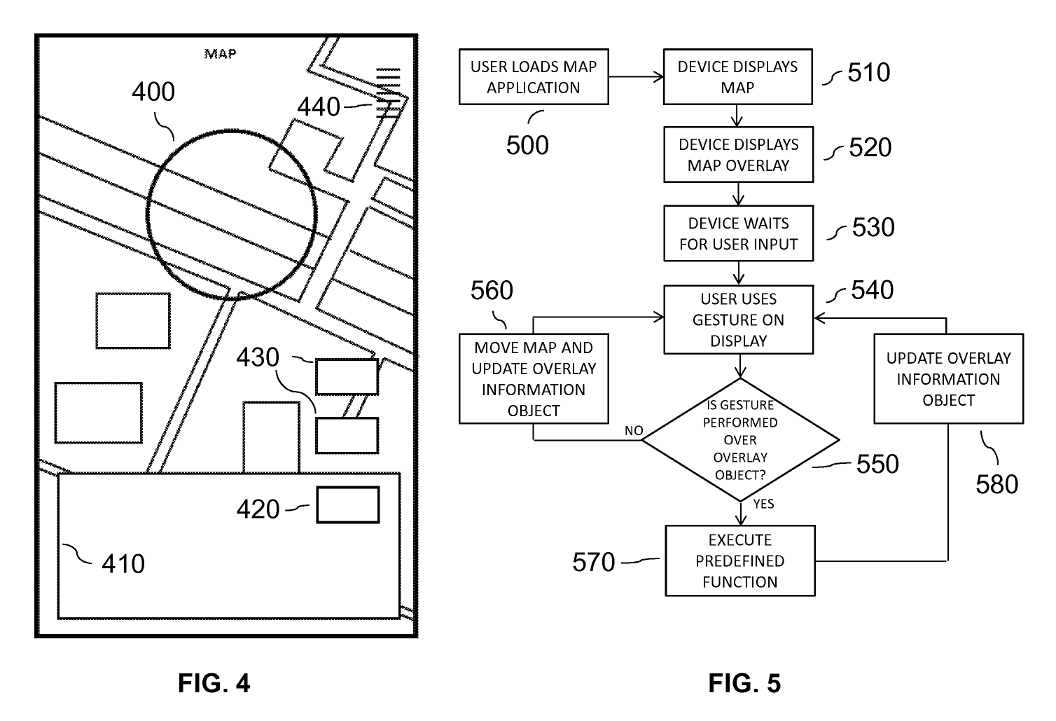

FIG. 4 shows FIG. 1 and FIG. 2 stacked together from the perspective of the user. Transparent objects on the overlay 400 may leave the map visible for the user. The user may move the map with a swipe of his finger across the transparent area or the transparent objects on the overlay. By moving the map, the user may change the selected area on the map 400. Information about the area marked by the transparent object 400 may be displayed in the information box 410. An additional button on the information box 420 may pull up further detailed information about the marked area 400 that may not have been displayed so far. Additional non-transparent buttons may be displayed on the overlay 430. These buttons may be programmed to invoke other functions that may be related to the marked area on the map 400. Small lines may be displayed on the overlay 440. The user may be able to zoom in and out of the map underneath the overlay by swiping his finger across the lines.

FIG. 5 is a process diagram describing a user input workflow. The user of the device may start the mapping application on the device 500. The device may initialize the map program and may display an initial map 510. As a second step the device may initialize the overlay and project it above the map 520. Once finished the device may switch into waiting mode and may wait for user input 530. The user may initiate an activity on the display with a finger gesture 540. The program code may check where on the overlay the user gesture has been performed 550. The program may determine that the user input has been performed above the transparent part of the overlay and thus the map underneath the overlay may be moved and a new area may be marked by the overlay as described in FIG. 4. The information relating to the new area may be updated in the information box 560. The program may determine that the user input was performed above one of the overlay objects linked to a predetermined function and may initiate that function 570. Finally, the program may update the information displayed in other overlay objects 580.

Although the embodiments above have been described in considerable detail, numerous variations and modifications will become apparent to those skilled in the art once the above disclosure is fully appreciated. It is intended that the following claims be interpreted to embrace all such variations and modifications.

1. A system for area marking comprising:
an electronic device;
at least one processors;
a memory coupled to the processors;
a map layer;
an overlay layer containing a plurality of transparent or non-transparent objects;
wherein the overlay layer has a transparent shape with border to mark area;
wherein the overlay layer covers the map layer;
wherein the memory stores program instructions which are executable by the processors to display a map with the overlay layer; the overlay layer covers over the map which at the same time marks an area on the map; user's inputs trigger the redrawing of the map on the display; this in turn changes the area on the map which is marked by the overlay layer.

2. The system of claim 1 further comprising: at least one object which displays information about the area marked on the map by the overlay layer.

3. The system of claim 1 further comprising: at least one object on the overlay layer Which is linked to predefined functions, user's input to such an object triggers the execution of the assigned predefined function and does not trigger the execution of map functions.

4. (canceled)

5. The system of claim 2 further comprising: at least one object on existing information displaying objects of the overlay layer, which triggers predefined functions, whereas such predefined functions either use the area marked on the map as input or affect the area in their output.

6. The system of claim 1 further comprising: at least one object on the overlay layer which helps the user to interact with the map.

7. The system of claim 6, wherein the user can use the object on the overlay layer to zoom the map in and out.

8. A method of controlling the area marking system of claim 1 comprising:
loading a map application;
displaying a map;
displaying a map overlay and projecting the map overlay above the map;
accepting an input from a user;
checking where on the overlay the user's input has been performed;
moving the map and updating the overlay information object if the input is not performed over overlay object;
executing predefined function if the input is performed over overlay object;
updating the overlay information object.
